(19) United States
(12) Patent Application Publication
(10) Pub. No.: US 2006/0081703 A1
(43) Pub. Date: Apr. 20, 2006

(54) Systems and methods for providing virtual reception services

(76) Inventor: Bao Q. Tran, San Jose, CA (US)

Correspondence Address: TRAN & ASSOCIATES, 6768 MEADOW VISTA CT., SAN JOSE, CA, 95135, US

(21) Appl. No.: 11/230,280

(22) Filed: Sep. 19, 2005

Related U.S. Application Data
(60) Provisional application No. 60/619,244, filed on Oct. 15, 2004.

(51) Int. Cl. G06K 5/00

(52) U.S. Cl. 235/382

(57) ABSTRACT

Systems and methods to provide remote facility management through a remote receptionist at a remote location; and a visitor data entry computer, including a processor having a camera to capture images of the visitor, a display to show the remote receptionist to the visitor and a speaker to reproduce verbal communication between the remote receptionist and the visitor.

This application is a continuation of Provisional Application Ser. No. 60/619,244, filed Oct. 15, 2004, the content of which is incorporated by reference.

### BACKGROUND

Today's rapid pace of business is supported in part by a fluid exchange of information between employees of a company and visitors such as consultants, vendors, suppliers, and other third parties. However, opening the company to strangers can expose the company to the possibility of lost or stolen property (both physical and intellectual property) and security breakdowns.

For example, by receiving third-parties and showing them company facilities without restriction, a company can lose its trade secret right. In determining whether to protect the company's trade secret, courts determine whether the company's actions indicated that it felt the information was valuable and took steps to prevent disclosure. Factors evaluated by courts in determining if information is a trade secret include the extent to which the information is known outside your company and the extent to which measures were taken by the company to guard the secrecy of the information. Courts are generally persuaded when the company can show (by objective evidence) that it believed the information was a trade secret. Monitoring and restricting traffic from outsiders can be used to show that the company has taken steps to protect its secrets.

To better monitor and control the influx of visitors, it has become commonplace to maintain a visitor log in a company's lobby. Typically, the log is paper-based, and a visitor manually writes his or her name in an entry in the log. For a company that is concerned about its proprietary rights, the company may require the visitor to sign an acknowledgement respecting the company's rights (such as confidentiality) in the visitor log. In certain companies, the visitor is issued a tag or a badge indicating the visitor status. This pen-and-paper approach is inexpensive and easy to use. However, the pen-and-paper approach is inconvenient when details for a particular visitor need to be retrieved or when statistics need to be collected on visitors. In such cases, records need to be manually searched, or the information has to be typed into a computer database for searching or other processing operations.

To address the need to collect and distribute information relating to company visits to better control the company's security needs, computerized systems have been developed. These systems are typically based on a personal computer (PC) where a receptionist typically enters information relating to the visit. Typically, information collected from a new visitor is added to the database when the receptionist fills in a data entry screen. The computer then prints a badge, tracks when the visitor enters and exits the company's facility, and monitors which employee being visited and the purpose of the meeting. However, conventional computerized visitor tracking systems can be expensive and complex to operate, and can take significant desk space. The cost and complexity of PC-based visitor tracking systems have limited their appeal, and the pen-and-paper approach to logging visitors is still the most common way of tracking visitors for many companies whose size or staff limitation precludes the deployment of a personal computer for tracking visitors.

Call centers are equipped and staffed for the provision to end-users of information services, especially technical support and reservation services. End-users may be: retail consumers, occupants of residential dwellings, hotel guests, tourists, employees of supply channel or distribution channel partners, consultants, internal staff, maintenance contract subscribers, travelers, among others.

Advanced call centers usually comprise: connectivity to public and private wide area networks, a call distribution system (either circuit switched or packet-switched, e.g., Voice over Internet Protocol, data call, instant message, for example), a local area network, applications software, World Wide Web servers, database servers, application servers, workstations, wide area network connectivity, and personnel who operate workstations or “seats” in the call center and interact with callers to the call center.

### SUMMARY

Systems and methods to provide remote facility management through a remote receptionist at a remote location; and a visitor data entry computer, including a processor having a camera to capture images of the visitor, a display to show the remote receptionist to the visitor and a speaker to reproduce verbal communication between the remote receptionist and the visitor.

In another aspect, systems and methods are disclosed for receiving a visitor that include capturing information on the visit from the visitor, including contact information and the visitor's signature; receiving contact information from a handheld computer carried by the visitor; storing information on the visit; and through a remote call center operator, calling an employee that a visitor is in the lobby, and facilitating the visit.

Advantages of the system may include one or more of the following. The system increases the company's building security while optimizing lobby traffic and transactions. The visitor enters data directly into the system by keyboarding the information or by beaming the information from a handheld computer belonging to the visitor that contains the required information. The data thus entered is accurately while minimizing the load on the receptionist. Pictures can be taken to authenticate the visitor. Automatic announcements of visitors can be generated through emails to persons being visited, further reducing the workload on the receptionist. The system minimizes unauthorized access and reduces potential loss due to theft. The system ensures that all visitors have left the building and none remain inside at the end of the day. The system also accounts for people on-site in the event of an emergency. These capabilities enhance the company's image as a secure and safe place to work.

The system is easy to set-up and is maintenance-free. The system is also customizable to a company's particular needs. For example, constraints and restrictions on the purpose of the visit can be imposed on the visitor through an easy to create short contract that is displayed for the visitor's assent. The system provides advanced reports and statistics on visitors at any time. Documentation can be generated for security investigations if needed.

Moreover, the receptionist work can be cost-effectively distributed across continents. The system allows companies to increase profits by directly or indirectly “outsourcing” certain projects to areas of the world that have an abundant supply of cost effective labor.

Other advantages and features will become apparent from the following description, including the drawings and claims.

### BRIEF DESCRIPTION OF THE DRAWINGS

The present invention can be more fully understood by reading the following detailed description together with the accompanying drawings, in which like reference indicators are used to designate like elements, and in which:

FIG. 1A shows an exemplary environment for capturing visitor information.

FIG. 1B shows an exemplary telecommunication structure.

FIG. 2A shows an exemplary method for receiving visitors using a call center.

FIG. 2B shows an exemplary process for logging-in a visitor using a registration system.

FIG. 3 shows a log-out process for the visitor using the registration system.

FIG. 4 illustrates an exemplary process for setting up the registration system.

FIG. 5 shows an exemplary process executed on a host computer for processing visitor data communicated from the registration system.

### DESCRIPTION

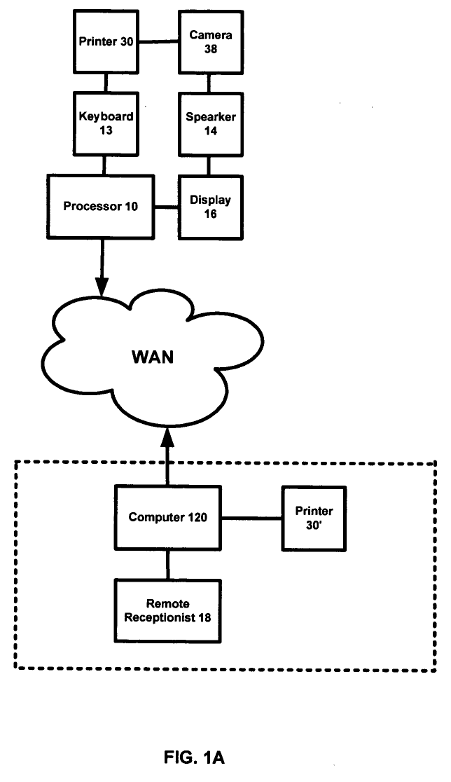

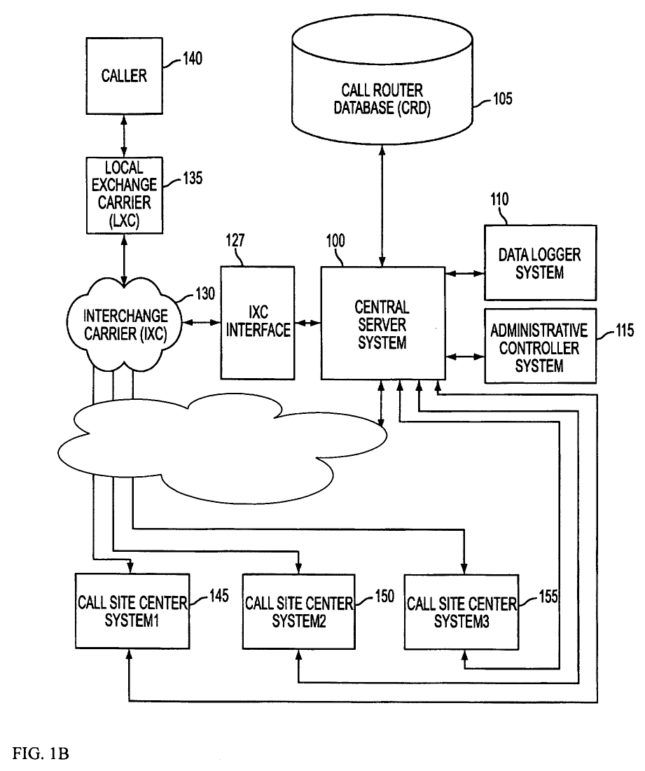

FIG. 1A shows an exemplary environment for capturing visitor information. The system of FIG. 1 includes a registration system 10 that is connected to a host computer 20. The registration system 10 provides an interface for capturing visitor information, including contact information, person being visited, signature assenting to visit restrictions imposed by the company, and a picture of the visitor. The registration system has a camera 38, an audio board 14 and a display 16 and is connected over a WAN to a remote call center 18. The remote call center 18 can be accessed over a satellite link or a fiber-optic link, for example. More details on the call center data and video transmission is discussed in common filed application Ser. No. 60/______, the content of which is incorporated by reference.

An operator at the remote call center 18 can view the visitor through the camera 12 and conversely the visitor can see the operator through the display 14. The operator and the visitor can verbally communicate using the audio board 14. The registration system 10 communicates the visit information to the host computer 20, which tabulates and performs verification that the visit is appropriate and tracks the visit. The system 10 has a keyboard 13 for accepting typed input, a touch-sensitive display 26 that can receive input from a pen, including signatures, and a camera 38 for capturing an image of the visitor or a computer-readable encoding on a badge so that the visitor can swipe the badge over the camera 38 and the system 10 would recognize that the visitor desires to end the visit. A badge printer 30 can be connected to either the registration system 10 or the host computer 20 to print a badge for the visitor. The printer 30 can encode computer readable code on the badge to identify the visitor, his clearance level, and applicable restrictions, for example.

In one embodiment where the registration system 10 is based on a handheld computer such as the Palm computer, the registration system 10 is light enough that it could be moved to a convenient height, as for example, to allow a disabled visitor in a wheelchair to readily complete the registration process. In the handheld computer example, the handheld computer is mounted on a keyboard to allow keyboard entry, although the visitor can also enter data using pen stroke or speech.

FIG. 1B shows an exemplary telecommunications network that supports remote sales support. In one embodiment, the system includes a server system 100; data logger system 110; administrative controller system 115; call router database 105; call site center system 1 145; call site center system 2 150; call site center system 3 155; IXC interface 127; inter-exchange carrier (IXC) 130; local exchange carrier 135; and caller 140.

Caller 140 represents the caller originating a call that is routed through the call routing system. The caller can be a consumer who seeks service from business concerns using the telephone. For example, a consumer seeking to place an order, schedule a delivery, file a complaint, or query an account balance may place a call to a centralized number provided by a business concern. It is well known that businesses often provide such numbers as so-called toll-free “800” numbers or the like.

Local exchange carrier (LXC) 135 represents that local phone network receiving a customer's call in a local area for forwarding to IXC 130. For example, a customer calling a toll-free 800 number is routed through his/her local phone network to the long distance network, IXC 130. IXC 130 represents the long distance carrier network that is controlled by central server system 100 to route calls to call sites and queues at the different geographic locations. While not depicted in FIG. 1, IXC 130 may further comprise a data access point (DAP) representing the point or node in the long distance switching network that receives return route address data to determine call destination.

The IXC 130 communicates over a network which can be ATM (Asynchronous Transfer Mode) with transport, switching, network management, and customer services built in. ATM is a protocol that handles multimedia traffic over wide area networks (WANs). The protocol is a connection-oriented cell-switched protocol developed for fiberoptic systems which have nearly error-free performance characteristics. The main features of ATM are guaranteed quality of service, ease of switching, and multimedia compliance. ATM can be easily switched because all switching and routing is performed by using only a 5 byte header. Thus, the switching can be performed with hardware. ATM is multimedia compliant because of the small cell size—a 5-byte header and a 48-byte payload. The small size allows cell delay (jitter) to be readily controlled—a necessity for multimedia transmission such as voice and video. The network may be satellite-based or fiber-optic cable based.

IXC interface 127 represents hardware/software that may be required to convert data transmitted between IXC 130 and central server system 100. Long distance carriers may have data formats (e.g., for the route request and return address) that differ among long distance providers and that may require conversion into a format usable by central server system 100. The IXC interface 127 permits the integration of computers and telephony (often referred to as CTI or computer telephony integration) for the call routing system.

The IXC interface 128 communicates with a central server system 100. The central server system 100 provides centralized control over the call routing and includes hardware and software for supporting system administration, database management, carrier network interface, and call site center systems. In general, the central server system 100 receives routing requests from interexchange carriers (IXC). The central server system processes routing requests, as well as other information, to issue a return route address to IXC to control where a call is routed. As will be discussed in greater detail below, sometimes the return route address causes a call to be forwarded to an IVR system and other times the call is forwarded to one of the call site center systems. While not depicted in FIG. 1B, one or more backup servers may be provided for purposes of redundancy to ameliorate or eliminate the effects of crashes, malfunctions and the like.

Regarding the communication between central server system 100 and the other system elements, the interface and protocol may comprise means familiar to those of skill in the art. The interface between system elements may be through direct connection or direct lines or may be over a network, such as the Internet, Wide Area Network (WAN), Local Area Network (LAN) or the like. In one embodiment, call site center systems 1-3 (blocks 145-155) interface with central server 100 over a WAN. Regarding data format for non-voice data (such as real-time status information transmitted from peripherals to central server system 100), TCP/IP protocol is used, although departures therefrom remain within the spirit and scope of the invention.

The central server 100 also communicates with a data logger system 110 for logging activity of the call routing system. For example, data logger system 110 may provide for the storage of records reflecting the path taken by every call entering the call routing system. Data logger 110 may store records reflecting activity levels of various peripherals, such as call centers, so that system administration personnel can evaluate long term loading levels. Data logger system 110 may provide for storage of both short-term transactional data and long term historical data.

The server 100 also communicates with a call router database (CRD) 105 with storage means for storing data for the call router system. CRD 105 can be hard drives, CD-ROM, optical drives and so on. Generally, CRD 105 is accessed by central server system 100 in order to retrieve customer identification and profile or behavior data in order to generate routing strategies and return addresses. CRD 105 is also controlled by central server system 100 to store transaction and history data reflecting activity on the call routing system.

Optionally, one or more interactive voice response (IVR) systems collect information from callers (e.g., using touch-tone activated voice menus) in order to route calls to the proper target, such as to a qualified agent at a queue at a call site. In the preferred embodiment, calls are first forwarded (i.e., pre-routed) to one of said IVR systems. Callers can receive automated servicing and access to their accounts using the touchstone controlled menus. Alternatively, callers seeking servicing by a live agent can “dial out” by entering “#” or the like. In that event, additional information can be received in order to recognize the proper account and provide the best return route address to IXC 130. In this embodiment, once the return route address (e.g., for post-routing) is determined by central server system 100, the call may be returned from the IVR to IXC 130 by using a technology such as so-called “take back and transfer” (TNT) technology supported by MCI Corp. Once the call is returned to IXC 130, it is routed to the proper target in accordance with the return route address.

Call site center systems 1-3 (blocks 145-155) comprise call sites for receiving calls forwarded by IXC 130. Generally, said call sites will comprise one or more so-called peripherals capable of receiving calls, such as local VRU's, PBX's (Private Branch Exchange), and ACD's (Automatic Call Distributors). The call sites generally include agents and agent workstations for human-assisted call processing, further discussed below.

In one embodiment, each call site center system interfaces with central server system 100 over a WAN, although those of ordinary skill will appreciate that the interface could encompass other packet-switched technologies for communication between remote systems, such via the Internet, World Wide Web, Internet Protocol Next Generation (IPng), Local Area Network (LAN) and the like. Central server call center interface 302 represents the hardware and software for the interface between call site center systems 145-155 and central server system 100 which, in the preferred embodiment, employs so-called TCP/IP data communications protocol.

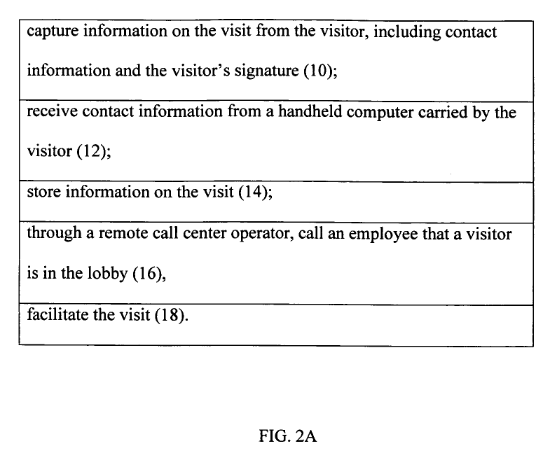

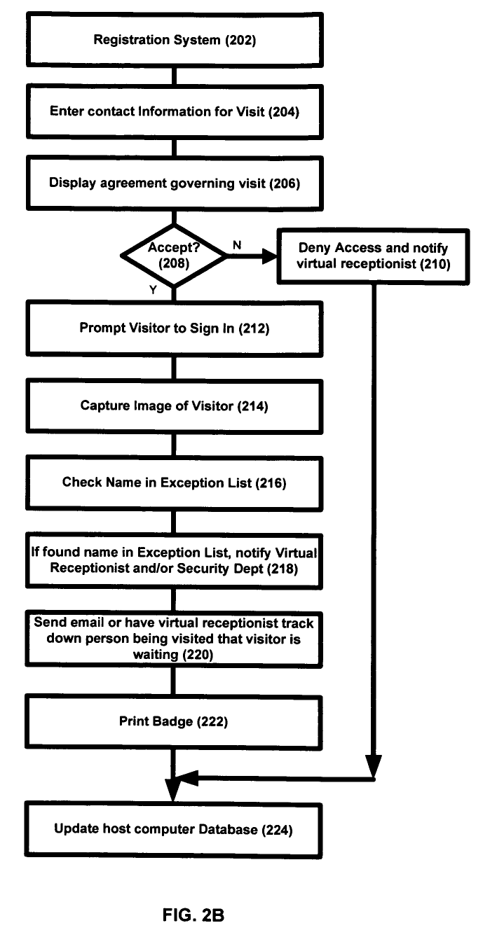

FIG. 2A shows an exemplary process for providing a virtual receptionist with a remote call center receptionist. The system captures information on the visit from the visitor, including contact information and the visitor's signature (210); receives contact information manually or from a cell phone or handheld computer carried by the visitor (212); stores information on the visit (214); through a remote call center operator, calls an employee that a visitor is in the lobby (216), and facilitates the visit (218).

FIG. 2B shows an exemplary process 300 for logging-in a visitor. Upon entering a company's lobby, the visitor introduces himself or herself to a receptionist, and is instructed to register using a registration system (step 302). As described in more detail below, the registration system has a keyboard and a touch sensitive display screen that accepts user input as well as signature. The registration system also has a communication port that can receive contact information from the visitor's handheld computer, if the visitor has one.

Using the registration system, the visitor can enter basic information about himself or herself and a desired contact person whom the visitor wishes to see (step 304). In one embodiment, the visitor types in his or her name, company affiliation, address, telephone, and the desired contact person. In another embodiment, the visitor can beam his or her basic contact information to the registration system and type in the name of the desired contact person.

Next, the registration system can display a basic agreement specifying the legal restrictions or requirements that the company imposes as terms for the visit (step 306). For example, if the company desires a signed non-disclosure agreement (NDA) before allowing access, the system displays a short NDA for the visitor to review. An exemplary NDA is shown in more detail in the example below. Other types of agreement can be displayed for the visitor to express assent before allowing access to the facility.

At this stage, the visitor can accept or reject the agreement (step 308). If the visitor rejects the agreement, the system denies access to the facility (step 310). Alternatively, if the visitor agrees, the system displays a signature area where the visitor executes the agreement by signing and where the visitor's signature is captured by the system (step 312).

In one optional variation, if the system is equipped with a camera, the system can take a snap shot of the visitor for verification purposes (step 314). In another optional variation, the system can optionally search a checklist of names that require exclusion from the facility or other special handling and verify that the visitor does not need to be excepted (step 316). If the visitor needs to be in an exception handling process, the system notifies the host computer and the receptionist to provide appropriate handling (step 318). People who may need special handling include a competitor's employee or consultant, and can include former employees of the company who had been fired, among others.

From step 316, if the visitor clears the checklist, the system sends an email to the person being visited that he or she has a guest waiting in the lobby (step 320). Further, if a printer is attached, the registration system can print the badge for the user to wear (step 322). If the printer is not available, the system can request the host computer to print the badge. An exemplary badge is shown below:

[image]

From step 310 or 322, the system updates visitor information in a database and communicates the captured information to a host computer for tabulating statistical information (step 324). The system then resets its display screen and loops back to step 302 to process the next visitor.

In one embodiment, the templates (such as the one for the nondisclosure agreement) could be tagged before hand to load for a specific visitor to sign. In another embodiment, the agreement can be selected based on the visitor's company affiliation. For instance, if the visitor indicates that he is affiliated with a competitor, a detailed nondisclosure agreement can be selected and displayed for the visitor to execute. In another embodiment, the agreement can be mailed, faxed, or emailed to the visitor prior to the actual visit for review.

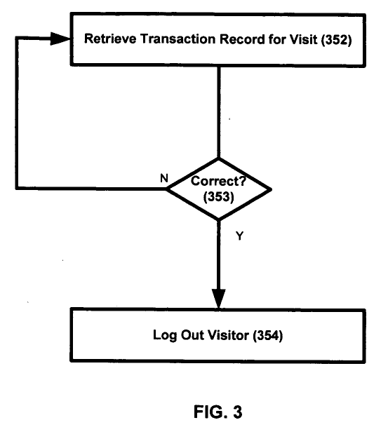

FIG. 3 shows a log-out process 350 where the visitor, at the end of the meeting, can conclude the transaction. In one embodiment, the visitor types in his or her name and perform a search on the database to retrieve transaction records for the visitor (step 352). In another embodiment with the camera, the visitor can scan the badge over the camera and the processor can process the computer-readable code on the badge to automatically locate the record for the transaction. Upon locating the right record for the transaction, the visitor can select a log-out button to end the transaction (step 354). The system then transfers the completed transaction file to the host computer for archival and for additional processing if desired.

As shown above, the visitor enters data directly into the system by keyboarding the information or by beaming the information from a handheld computer belonging to the visitor that contains the required information. The data is accurately taken while minimizing the load on the receptionist. Pictures can be taken to authenticate the visitor. Automatic announcements of visitors can be generated through emails to persons being visited, further reducing the workload on the receptionist. The system minimizes unauthorized access and reduces potential loss due to theft. The system ensures that all visitors have left the building and none remain inside at the end of the day. The system also accounts for people on-site in the event of an emergency. These capabilities enhance the company's image as a secure and safe place to work.

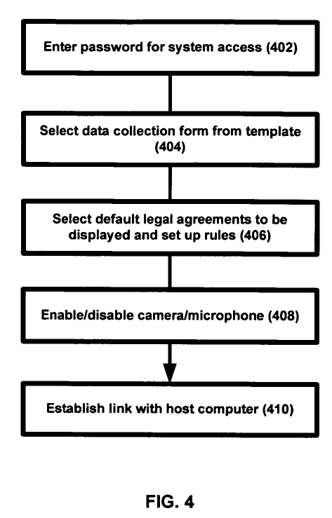

FIG. 4 illustrates an exemplary process 400 for setting up the registration system. Upon power-on, a company representative or user enters a password for accessing and controlling the registration system (step 402). Next, the user selects a data collection form from various templates (step 404). For example, one template is a simplified data collection form collecting only name of the visitor, the visitor's company, and contact name. Yet another template can ask in detail contact information for the visitor, including address and email information. The user also selects one or more short legal agreements that set the term of engagement between the company and the visitor (step 406). The user also designate rules relating to dynamic selection of the agreements. For example, the user can designate if a visitor belongs to a first list of company affiliations, use one form, and if a visitor belongs to a second list of company affiliations, use a second form. In this manner, the user can specify that visitors from direct competitors sign a highly detailed NDA, while visitors from clients or customers sign a basic acknowledgement of proprietary rights. If a camera and a microphone are available, the system can also prompt the user to enable or disable these options (step 408). The system also queries the user as to whether a host computer is available, and if so, establishes a link and initializes communications with the host computer (step 410). At this stage, the registration system has been set-up.

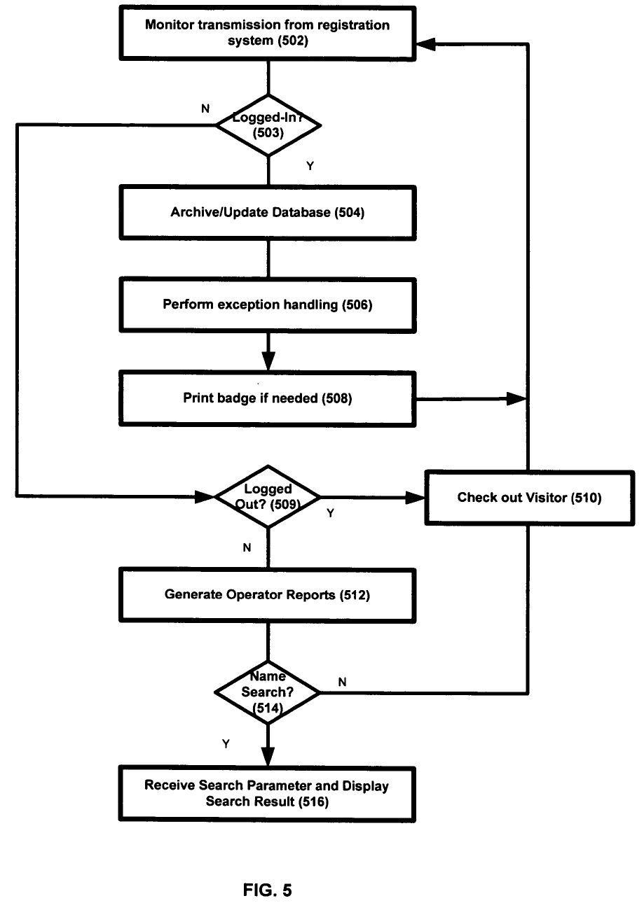

FIG. 5 shows an exemplary process 500 executed on the host computer for processing visitor data communicated from the registration system. Upon boot-up, the host computer checks for transmissions from the registration system by monitoring its communication ports for a registration event from the registration system (step 502). In one embodiment, the registration event is sent upon the completion of a visitor registration (log-in) and a second registration event is sent when the visitor completes the visit and logs-out.

The system checks whether the event is a log-in registration event (step 503), and if so, the host computer updates its database and archives the event (step 504). Also, the host computer looks up an exception list for visitors who should be specially handled (step 506). If the visitor needs special handling, the host computer can send messages to appropriate building security personnel. Further, if the visitor is cleared and no printer is attached to the registration system, the host computer prints out a badge (step 508) before exiting.

From step 502, the system checks whether the event is a log-out event (step 509), and if the event is a log-out registration event, the host computer notes that the visitor has checked-out (step 510) before exiting.

From step 509, if the event is not a log-out event, the system checks whether an operator wishes to view reports on pending visitors, and if so, the system generates a report for the operator (step 512). Additionally, the system checks whether a search for a particular name is desired (step 514) and if so, allows the operator to search for a name (step 516) before exiting.

An exemplary registration system hardware is discussed next. The system is preferably housed in a small, rectangular enclosure. A processor or central processing unit (CPU) provides the processing capability for the sketching system of the present invention. The processor can be a reduced instruction set computer (RISC) processor or a complex instruction set computer (CISC) processor. Preferably, the processor is a low power CPU. The processor is connected to a read-only-memory (ROM) for receiving executable instructions as well as certain predefined data and variables. The processor is also connected to a random access memory (RAM) for storing various run-time variables and data arrays, among others. The RAM is sufficient to store user application programs and data. In this instance, the RAM can be provided with a back-up battery to prevent the loss of data even when the computer system is turned off. However, it is generally desirable to have some type of long term storage such as a commercially available miniature hard disk drive, or non-volatile memory such as a programmable ROM such as an electrically erasable programmable ROM, a flash ROM memory in addition to the ROM for data back-up purposes. The RAM stores a database of the drawings of present invention, among others.

The processor is also connected to a real-time clock/timer which tracks time. The clock/timer can be a dedicated integrated circuit for tracking the real-time clock data, or alternatively, the clock/timer can be a software clock where time is tracked based on the clock signal clocking the processor. In the event that the clock/timer is software-based, it is preferred that the software clock/timer be interrupt driven to minimize the CPU loading. However, even an interrupt-driven software clock/timer requires certain CPU overhead in tracking time. Thus, the real-time clock/timer integrated circuit is preferable where high processing performance is needed.

The computer system receives instructions from the user via one or more switches such as push-button switches. Further, in one embodiment where the computer accepts handwritings as an input medium from the user, a combination pen/digitizer unit, and a display LCD panel having a viewing screen exposed along one of the planar sides of the enclosure are provided. The assembly combination of the pen/digitizer and the LCD panel serves as an input/output device. When operating as an output device, the screen displays computer-generated images developed by the CPU. The LCD panel also provides visual feedback to the user when one or more application software execute. When operating as an input device, the display assembly senses the position of the tip of the pen or stylus on the viewing screen and provides this information to the computer's processor. Certain display assemblies can also sense the pressure of the stylus on the screen to provide further information to the CPU.

This embodiment accepts pen strokes from the user using a stylus or pen which is positioned over a digitizer. As the user “writes,” the position of the pen is sensed by the digitizer of the pen/digitizer unit via an electromagnetic field as the user writes information to the data logger computer system. The digitizer portion of the pen/digitizer unit converts the position information to graphic data that are transferred to a graphic processing software of the data logger computer system. The data entry/display assembly of pen-based computer systems permits the user to operate the data logging computer system as an electronic notepad. For example, graphical images can be input into the pen-based computer by merely moving the stylus over the surface of the screen. As the CPU senses the position and movement of the stylus, it generates a corresponding image on the screen to create the illusion that the pen or stylus is drawing the image directly upon the screen. The data on the position and movement of the stylus is also provided to handwriting recognition software, which is stored in the ROM and/or the RAM. The handwriting recognizer suitably converts the written instructions from the user into text data suitable for saving time and expense information. Preferably, the handwriting recognizer of the present invention recognizes non-cursive characters. The non-cursive handwriting recognizer recognizes fixed style characters using a basic character set, preferably a 36-character alphanumeric character set. In addition to the basic 26 letters and 10 digits, the non-cursive handwriting recognizer includes multistep pen strokes that can be used for punctuation, diacritical marks, and capitalization. Preferably, the non-cursive handwriting recognizer is a software module called GRAFFITI, commercially available from Palm Computing, Inc. of Santa Clara, Calif.

Alternatively, voice recognition can be used in conjunction with and/or replace the handwriting recognizer of the present invention. A microphone can be connected to an analog to digital converter (ADC) which interfaces with the central processing unit (CPU). A speech recognizer is stored in the ROM and/or the RAM. The speech recognizer accepts the digitized speech from the ADC and converts the speech into the equivalent text. As disclosed in U.S. application Ser. No. 08/461,646, filed Jun. 5, 1995 by the present inventor and hereby incorporated by reference, the user's speech signal is next presented to a voice feature extractor which extracts features using linear predictive coding, fast Fourier transform, auditory model, fractal model, wavelet model, or combinations thereof. The input speech signal is compared with word models stored in a dictionary using a template matcher, a fuzzy logic matcher, a neural network, a dynamic programming system, a hidden Markov model (HMM), or combinations thereof. The word model is stored in a dictionary with an entry for each word, each entry having word labels and a context guide. Next, a word preselector receives the output of the voice feature extractor and queries the dictionary to compile a list of candidate words with the most similar phonetic labels. These candidate words are presented to a syntax checker for selecting a first representative word from the candidate words, as ranked by the context guide and the grammar structure, among others. The user can accept or reject the first representative word via a voice user interface. If rejected, the voice user interface presents the next likely word selected from the candidate words. If all the candidates are rejected by the user or if the word does not exist in the dictionary, the system can generate a predicted word based on the labels. Finally, the voice recognizer also allows the user to manually enter the word or spell the word out for the system. In this manner, a robust and efficient human-machine interface is provided for recognizing speaker independent, continuous speech and for converting the verbal instructions from the user into text data suitable for capturing time and expense information.

The CPU communicates with the camera 638 for capturing an image of the visitor. The camera can also capture a computer-readable encoding on a badge so that the visitor can swipe the badge over the camera 38 and the encoded information can be captured by the camera and the CPU and the system would recognize that the visitor desires to end the visit.

The computer system is connected to a two-way communication device for receiving instructions over the narrowband radio waves. Preferably, the two-way communication device is a pager where the user can receive as well as transmit messages. Alternatively, the two-way communication device can be substituted with a cellular telephone.

The computer system is also connected to one or more input/output (I/O) ports which allows the CPU to communicate with a host computer for data archival purposes. Each of the I/O ports may be a parallel port, a serial port, a PCMCIA port, or alternatively, a proprietary port to enable the computer system to dock with the host computer. After docking, the I/O ports and software located on the host computer supports the automatic synchronization of data between the computer system and the host computer. During operation, the synchronization software runs in the background mode on the host computer and listens for a synchronization request or command from the computer system of the present invention. Changes made on the computer system and the host computer will be reflected on both systems after synchronization. Preferably, the synchronization software only synchronizes the portions of the files that have been modified to reduce the updating times. In addition to supporting the docking function, the I/O port is adapted to be connected to a fax-modem which is adapted to receive information over the phone line or over the radio frequencies (wireless modem) and allow the user to access information remotely. Further, the modem may serve as part of a wide-area-network to allow the user to access additional information. The fax-modem can receive drawings and text annotations from the user and send the information over a transmission medium such as the telephone network or the wireless network to transmit the drawings/text to another modem or facsimile receiver, allowing the user to transmit information to the remote site on demand. The fax-modem can be implemented in hardware or in software with a few components such as a DAA, as is known in the art. Alternatively, the fax-modem device can be a two-way communication device which can receive text messages and graphics transmitted via radio frequency to the user for on-the-spot receipt of messages.

The registration system in combination with the host computer provides a fast, easy and complete way to manage visitor and event registration. The host computer allows the operator to verify, record and check-in a visitor, print a professional quality badge, track where and when they entered and exited a company's facility and monitor who was visited and why. The system supports querying, reporting, event registration, batch badge printing and check-in and check-out so that a company can effectively and securely manage its visitor information.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A computer to provide reception services for a visitor at a visited facility, comprising:
a remote receptionist at a remote facility;
a remote camera, a remote audio device and a remote display at the remote facility to provide audio-visual feedback to the remote receptionist;
a processor; a camera, an audio device and a display coupled to the processor at the visited facility to communicate and provide audio-visual communication between the remote receptionist and the visitor;

2. The computer of claim 1, including a touch screen display to capture information on the visit from the visitor, including contact information and the visitor's signature, the audio device and the touch-screen display

3. The computer of claim 1, further comprising a keyboard coupled to the processor to capture typed information on the visit from the visitor.

4. The computer of claim 1, further comprising a printer coupled to the processor to print a badge.

5. The computer of claim 4, wherein the printer prints computer readable code on the badge.

6. The computer of claim 1, wherein the camera captures a bar-code from the visitor's badge.

7. The computer of claim 6, wherein the bar-code is scanned at the end of the visit to identify the visitor at the end of the visit.

8. The computer of claim 1, further comprising a microphone coupled to the processor to capture a sound clip from the visitor.

9. The computer of claim 1, wherein the processor sends an announcement to a contact person that the visitor is waiting.

10. A system for registering a visitor, comprising:
a remote receptionist at a remote location; and
a visitor data entry computer, including a processor having a camera to capture images of the visitor, a display to show the remote receptionist to the visitor and a speaker to reproduce verbal communication between the remote receptionist and the visitor.

11. The system of claim 10, wherein the remote location is coupled to a satellite link.

12. The system of claim 10, wherein the remote location is coupled to a fiber-optic link.

13. A method for providing a virtual receptionist using a call center, comprising:
capturing information on the visit from the visitor, including contact information and the visitor's signature; and
through a remote call center operator, notifying an employee that a visitor is in the lobby, and facilitating the visit.

14. The method of claim 13, comprising printing a badge through a printer coupled to the processor.

15. The method of claim 13, comprising a camera to capture an image of the visitor.

16. The method of claim 13, wherein the camera captures a bar-code from the visitor's badge.

17. The method of claim 13, wherein the bar-code is scanned at the end of the visit to identify the visitor at the end of the visit.

18. The method of claim 13, wherein the remote call center is coupled to a satellite link.

19. The method of claim 13, wherein the remote call center is coupled to a fiber-optic link.

20. The method of claim 13, wherein the telephone is a cellular telephone.
